(19) United States
(12) Patent Application Publication
(10) Pub. No.: US 2004/0042712 A1
(43) Pub. Date: Mar. 4, 2004

(54) Low cost implemented optical add/drop device

(76) Inventors: Seung Hyun Cho, Guri (KR); Eui Suk Jung, Daejeon (KR); Byoung Whi Kim, Anyang (KR); Hyeong Ho Lee, Daejeon (KR)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/397,592

(22) Filed: Mar. 26, 2003

(30) Foreign Application Priority Data
Aug. 29, 2002 (KR) 2002-51387

(51) Int. Cl. G02B 6/28

(52) U.S. Cl. 385/24

(57) ABSTRACT

The present invention provides a low cost implemented optical add/drop device suitable for application in a WDM based optical subscriber network that assigns a unique wavelength to each subscriber, which uses an inexpensive optical tap coupler device and an usual optical fiber Bragg grating, simplifying the configuration and manufacturing process, while having relatively high quality performance. The optical add/drop device according to the present invention uses a combination of an optical tap coupler and an optical fiber Bragg grating, instead of a combination of an optical circulator and an optical fiber Bragg grating. Therefore, the cost is 10 times lower than an add/drop device adopting the optical circulator, and the configuration is simple. In addition, the implementation is very easy because the already-existing mature components can be utilized as they are.

### BACKGROUND OF THE INVENTION

1. Field of the Invention

The present invention relates to an optical add/drop device, and more particularly to a low cost implemented optical add/drop device that allows each subscriber at subscriber nodes of a WDM (wavelength division multiplex) based optical subscriber (access) network to add or drop an single wavelength optical signal among WDM multi-wavelength optical signals, which is assigned to the each user, using optical couplers and a fiber Bragg grating.

2. Description of the Prior Art

The WDM based optical subscriber network is one of the most intensively studied fields in the world. Such a WDM based optical subscriber network must be equipped with a device with a function to add or drop each of channels (wavelengths) being transferred on the network to or from any subscriber node.

Three main types of optical add/drop devices have been proposed. The first type uses two optical circulators and one optical fiber Bragg grating. The second type uses a Mach-Zehnder interferometer that is formed of two 3-dB optical couplers, wherein two fiber Bragg gratings of the same characteristics are inscribed on two arms with the Mach-Zehnder interferometer, respectively, and optical path difference between the two arms should be controlled for operations. The third type uses an optical fiber coupler on which an optical fiber Bragg grating is formed.

After being commercialized, the first type of optical add/drop device is currently used most widely. As shown in FIG. 1, this type of optical add/drop device comprises first optical circulator 110, second optical circulator 120, and an optical fiber Bragg grating 130. Operating principle is as follows. When WDM multi-wavelength optical signals are injected into the input port 111, the injected signals wholly pass through the first optical circulator 110, and are then transmitted toward the optical fiber Bragg grating 130 through an output port 112 of the first optical circulator 110. When the optical signals encounters the Bragg grating 130, one of the optical signals with the same wavelength as the resonance wavelength of the fiber Bragg grating 130 is reflected from the fiber Bragg grating 130, returning to the first optical circulator 110. The reflected optical signal returns to the first optical circulator 110 through the output port 112 of the first optical circulator 110, and then came out of another output port 113 of the first optical circulator 110 according to the operating principle of the optical circulator. The another output port 113 of the first optical circulator 110 is called a drop port. Meanwhile, the remaining optical signals independent from the resonance wavelength of the fiber Bragg grating 130 pass through the fiber Bragg grating 130 without being affected thereby, and are injected into the second optical circulator 120 through an input port 121 of the second optical circulator 120 thereof. Above mentioned, remaining optical signals without resonance wavelength signal of the fiber Bragg grating 130 are transmitted from the second optical circulator 120 through an output port 122 of the second optical circulator 120 thereof. On the other hand, in the case of adding or inserting a specific optical signal, an optical signal with the same wavelength as the resonance wavelength of the Bragg grating 130 is injected into the second optical circulator 120 through another input port 123 thereof, and then transmitted from the second optical circulator 120 through the output port 123 of thereof. The transmitted optical signal through the output port 123 of the second optical circulator 120 is reflected from the fiber Bragg grating 130, returning to the second optical circulator 120. The returned optical signal passes through the second optical circulator 120, and is re-transmitted through the output port 122 of the second optical circulator 120 according to the operating principle of the optical circulator, together with the remaining optical signals that were not influenced by the fiber Bragg grating 130 as mentioned above. Such an optical add/drop device composed of two optical circulators and an optical fiber Bragg grating has low insertion loss and high add/drop efficiency characteristics, but is expensive and large in size because of using the optical circulators.

The second type of optical add/drop device uses a Mach-Zehnder interferometer composed of two 3 dB optical couplers 210 and 220, instead of the optical circulators. FIG. 2 shows one example of the second type of optical add/drop device. Multi-wavelength optical signals are injected into the optical add/drop device through an input port 211 thereof, and, after passing through a first 3 dB optical coupler 210, the optical signals are split and go into two output ports 213 and 214 of the first 3 dB optical coupler 210. When the split optical signals are incident on the fiber Bragg gratings 230 and 240, respectively, optical signals with the same wavelength as the resonance wavelength of the fiber Bragg gratings 230 and 240 are reflected backwardly from the Bragg gratings 230 and 240, whereas the remaining optical signals independent from the resonance wavelength travel toward the second 3 dB optical fiber coupler 220 without being affected. The optical signals reflected from the Bragg gratings 230 and 240 again pass through the first optical fiber coupler 210, and come out of the drop port 212. Here, it is to be noted that because the optical signals to be extracted through the drop port 212 may be partially reflected toward the input port 211 while passing through the first optical fiber coupler 210, it is very important to make the lengths of both arms of the Mach-Zehnder interferometer equal to each other, and to correctly place the optical fiber Bragg gratings having the same properties at the same position of the two arms. This is for the following reasons. When the two arms have the same length, the optical path difference between the two split lights is zero, so that the two split lights interfere constructively in the first optical coupler, allowing nearly 100% thereof to come out of the drop port. In addition, only when gratings having the same reflectivity and resonance wavelength are located at the same position of the two arms can high drop efficiency be achieved, owing to the interference of the reflected lights. Meanwhile, as mentioned above, the optical signals independent from the resonance wavelength of the fiber Bragg gratings 230 and 240 pass through the fiber Bragg gratings 230 and 240, and are transmitted through the output port 224 of the second 3 dB optical coupler 220. Also in this case, only when the optical path difference between the two split lights is zero, the two split lights interfere constructively, allowing nearly 100% thereof to be transmitted through the output port 224. The add operation is performed by the same principle as the drop operation. That is, an optical signal with the same wavelength as the resonance wavelength of the fiber Bragg gratings is injected into another output port 223 of the second 3 dB optical coupler 220 in the Mach-Zehnder interferometer, and the injected optical signal is split into two paths 221 and 222 after passing through the second 3 dB optical coupler 220. The split optical signals are reflected from the fiber Bragg gratings, and travel in the backward direction. After passing again through the second 3 dB optical coupler, the inserted (added) optical signal is transmitted through the output port 224. As mentioned above, such an optical and/drop device using a Mach-Zehnder interferometer composed of two 3 dB optical couplers is inexpensive, relative to the optical add/drop device using the optical circulator. However, the second type of optical add/drop device has a problem that it is very difficult to correctly adjust the optical path difference between the two arms of the Mach-Zehnder interferometer to be equal to zero. In addition, the second type has low reliability, relative to the conventional optical add/drop devices, because the optical path difference and the properties of the optical fiber Bragg gratings are very sensitive to changes in the external environment.

FIG. 3 shows the configuration of the third type of optical add/drop device, which is called an optical fiber coupler type of optical add/drop device. In order to add and drop (or insert and extract) a wavelength signal, this type of optical add/drop device forms optical fiber Bragg gratings in an optical coupling region of the optical coupler that is made by polishing or fusing together two single-core optical fibers. The operating principle of the third type is described as follows referring to FIG. 3. Two optical fibers 370 and 380 include optical fiber Bragg gratings 350 and 360 having the same length, period and reflectivity, respectively. The Bragg gratings 350 and 360 are positioned at the center of the optical coupling region of the optical coupler where the lights are coupled together, and the lengths of the Bragg gratings are shorter than length of the coupling region of the coupler in order to reduce the dependency on their own position and obtain a high reflection ratio. This optical fiber coupler has to have low coupling coefficient so as to obtain full forward power transfer.

When multi-wavelength optical signals independent from the resonance wavelength of the Bragg gratings are injected into the input port 310, the signals are transmitted through the output port 340 after being subjected to the full forward power transfer procedure according to the operating principle of the directional optical fiber coupler. When the wavelength of the optical signal is equal to the resonance wavelength of the Bragg gratings 350 and 360, the Bragg grating operates like a reflector to reflect the optical power toward a drop port 320. The add operation is performed by the same principle as the drop operation. This optical fiber coupler type is inexpensive and simple in configuration, but its manufacturing procedure is very difficult, and its loss and spectral properties are not good.

One example of the optical add/drop device using such an optical tap coupler and fiber Bragg grating was disclosed in IEE Electronic Letters 26(11) (R. KAHSYAP, etc.) in 1990. However, this prior art is known to have an insertion loss of about 6 dB during the add/drop operation because of using two 50/50 optical couplers (conventional 3 dB fiber coupler) and one optical fiber Bragg grating, and thus it is not suitable for application in an actual WDM optical transmission system.

Meanwhile, an optical add/drop device was disclosed in Korean patent application No. 1994-33165. It is expensive to realize the device of this prior art because of using an optical circulator and two Fabry-Perot type filters. In addition, a WDM optical communication system and an add/drop device were disclosed in U.S. Pat. No. 5,457,758. However, this prior art has a problem that, because an optical fiber coupler that causes evanescent coupling is used, it is very difficult to form a grating in the coupling region of the optical fiber coupler, thereby lowering its performance.

### SUMMARY OF THE INVENTION

Therefore, it is an object of the present invention to provide an optical add/drop device suitable for application in a WDM optical subscriber network that assigns a unique wavelength to each subscriber, which uses an inexpensive optical splitting/coupling means and an optical transmitting/reflecting means, simplifying the configuration and manufacturing process, while having relatively high quality performance.

In accordance with the present invention, the above and other objects can be accomplished by the provision of an optical add/drop device for use in a WDM (Wavelength division Multiplexing) based optical subscriber network, the device comprising: a first optical splitting/coupling means for receiving, as input signals, WDM multi-wavelength optical signals, splitting the received optical signals according to a specific coupling ratio, outputting the split optical signals, splitting an optical signal having a specific wavelength, among the outputted multi-wavelength optical signals, which come back after being reflected, and extracting the split optical signal; an optical transmitting/reflecting means for reflecting the optical signal having the specific wavelength among the multi-wavelength optical signals outputted from the first optical splitting/coupling means toward the first optical splitting/coupling means, and passing the multi-wavelength optical signals having the remaining wavelengths other than the specific wavelength; and a second optical splitting/coupling means for receiving the multi-wavelength optical signals exiting from the optical transmitting/reflecting means, inserting a new optical signal having a specific wavelength, combining the inserted optical signal and the received optical signals according to a specific coupling ratio, and outputting the combined optical signals.

Preferably, the first optical splitting/coupling means has a coupling ratio of 90% or more, and the second optical splitting/coupling means has a coupling ratio of 50%.

Preferably, the first optical splitting/coupling means inserts, as the insertion signal, the new optical signal having the same wavelength band as that of the extracted optical signal, and the second optical splitting/coupling means combines the inserted optical signal and the received optical signals at the same power level.

In addition, the optical transmitting/reflecting means reflects an optical signal with a wavelength equal to a predetermined resonance wavelength of the optical transmitting/reflecting means, among the multi-wavelength optical signals outputted from the first optical splitting/coupling means, toward the first optical splitting/coupling means.

Preferably, the first and second optical splitting/coupling means may be tap couplers, and the optical transmitting/reflecting means may be an optical fiber Bragg grating.

As mentioned above, for implementing an optical add/drop device widely used in a WDM optical transmission network, the present invention can use an optical tap coupler, as a splitting/coupling means, in order to overcome the problems caused by using a high cost, large-sized optical circulator. Particularly, according to the present invention, the conventional 50/50 optical tap coupler can be used for inserting (adding) and outputting operations, and an optical tap coupler with 90% or more coupling ratio can be used for inputting and extracting (dropping) operations. Thereby, the insertion loss of optical signals which have transmitted through the present invention, optical add/drop device is lower than about 3.1 dB, and the insertion loss of the extracted (dropped) optical signal having the same wavelength as the resonance wavelength of the Bragg grating, as a transmitting/reflecting means, is about 20 dB. Of course, the insertion/extraction (add/drop) efficiency wholly depends on the reflectivity of the optical fiber Bragg grating. Therefore, the present invention can utilize a widely used optical fiber Bragg grating commercialized for obtaining high insertion/extraction (add/drop) efficiency and high spectral properties. There is a disadvantage in that the insertion loss of the extracted signal and insertion loss of the transmitted signal is high as mentioned above. But, in the case of a network such as an optical subscriber network with low data transmission rate, it is found that the extracted (dropped) signal can be satisfactorily detected by using an optical receiver of high reception sensitivity (lower than −40 dBm at 155 Mbps). Meanwhile, the inserted (added) signal and the transmitted signal (independent from the resonance wavelength of the fiber Bragg grating) also experience an insertion loss of about 3 dB while passing through the 50/50 optical tap coupler. However, it is judged that these effect of high insertion loss's influence on the optical signal power can be minimized by compensating the insertion loss with a commonly available low cost optical amplifier commercialized for use in Metro or optical subscriber networks.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a view showing the structure of an optical add/drop device according to one example of the prior art;

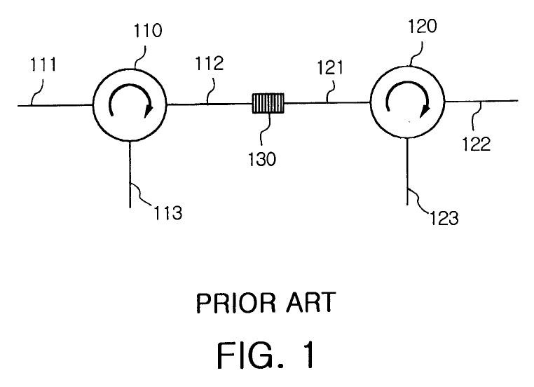

FIG. 2 is a view showing the structure of an optical add/drop device according to another example of the prior art;

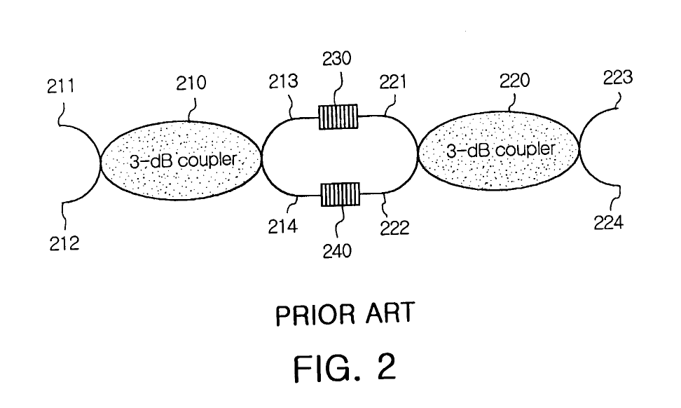

FIG. 3 is a view showing the structure of an optical add/drop device according to still another example of the prior art;

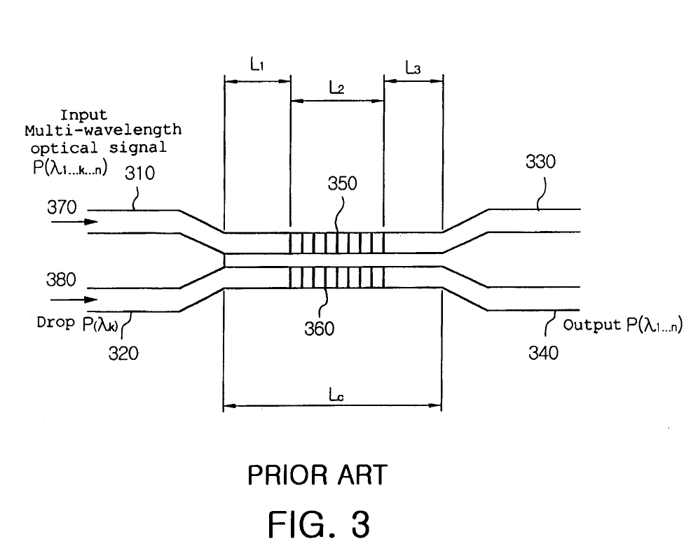

FIG. 4 is a view showing the structure of an optical add/drop device according to one embodiment of the present invention; and

FIG. 5 is a conceptual view illustrating the operation of adding and dropping an optical signal in the optical add/drop device according to the embodiment of the present invention.

### DESCRIPTION OF THE PREFERRED EMBODIMENTS

Hereinafter, a preferred embodiment of the present invention is described in detail referring to the drawings.

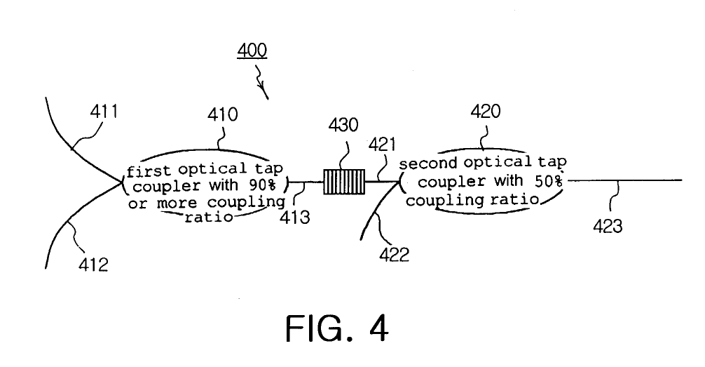

FIG. 4 is a view showing the configuration of an optical add/drop device according to the preferred embodiment of the present invention, which uses an optical tap coupler and an optical fiber Bragg grating. An optical add/drop device 400 shown in FIG. 4 is only a preferred embodiment of the present invention that is described for illustrative purposes, and therefore it is to be noted that various modifications, additions and substitutions are possible, without departing from the spirit of the invention.

As mentioned above, according to one embodiment of the present invention, the first and second splitting/coupling means may include tap coupler, respectively, and the transmitting/reflecting means may include a fiber Bragg grating.

As shown in FIG. 4, the optical add/drop device 400 includes a first optical tap coupler 410 with 90% or more coupling ratio (for example, 90/10, 95/5, 99/1), a fiber Bragg grating 430, and a second optical coupler 420 with 50/50 coupling ratio. Referring to FIG. 4, the first optical tap coupler 410 with 90% or more coupling ratio includes an input port 411, an output port 413, and a drop port 412. The input port 411 receives multi-wavelength optical signals. The output port 413 of the first optical tap coupler 410 carries 90% or more (for example, 90%, 95%, 99%) of the input optical power toward the optical fiber Bragg grating 430. The drop port 412 is used for extracting (dropping) a specific wavelength signal that is reflected from the Bragg grating 430. Preferably, the optical fiber Bragg grating 430 is formed of a usual optical fiber Bragg grating that is widely used after being commercialized and has properties of reflecting a specific wavelength signal and wholly passing the remaining wavelength signals. The second optical tap coupler 420 with 50/50 coupling ratio includes an input port 421, an output port 423, and an add port 422. The input port 421 receives multi-wavelength optical signals exiting from the optical fiber Bragg grating 430. The output port 423 carries 50% of the optical power which is incident on the input port 421. The add port 422 receives an add signal having the same wavelength band as the extracted (dropped) wavelength optical signal.

The operating principles of the optical add/drop device having the configuration mentioned above according to the present invention are described in detail as follows. Multi-wavelength optical signals are launched into the input port 411 of the first optical tap coupler 410 with 90% or more coupling ratio. The launched signals are transmitted to the output port 413 after passing through the first optical tap coupler 410, where the power of the output signals is determined by the coupling ratio of the first optical tap coupler 410. Also, the insertion loss is determined by the coupling ratio. That is, in the case of using 99/1 optical tap coupler 410 with 99% coupling ratio, the insertion loss of the signal traveling from the input port 411 to the output port 413 is theoretically about 0.04 dB, in the case of using 95/5 optical tap coupler 410 with 95% coupling ratio, it is about 0.22 dB, and in the case of 90% coupling ratio, it is about 0.45 dB. Like these, the insertion loss varies according to the coupling ratio of the used optical tap coupler. Therefore, when the add/drop device of the present invention is applied in the actual case, more preferable results can be obtained by optimally determining the coupling ratio of the optical tap coupler which is constructed in the present invention according to its field of application. Actually, when using an optical tap coupler with 99% coupling ratio, the passed channel signal loss can be minimized. Accordingly, it is preferable to use an optical tap coupler with 99% coupling ratio for unaffecting the pass channel signal quality. Traveling from the output port 413 of the first optical tap coupler 410 with 90% or more coupling ratio, the optical signals encounter the fiber Bragg grating 430. When the optical signals encounter the fiber Bragg grating 430, an optical signal having the same wavelength as the resonance wavelength of the fiber Bragg grating 430, of the multi-wavelength optical signals injected into the input port 411, is reflected backward from the fiber Bragg grating 430. Of course, the remaining optical signals independent from the resonance wavelength of the fiber Bragg grating 430 wholly pass through the fiber Bragg grating 430 without being affected thereby, and are incident on the input port 421 of the second optical tap coupler 420. The important feature of the second optical tap coupler 420 is to combine the multi-wavelength optical signals exiting from the Bragg grating 430 with the added optical signal having the same wavelength as the wavelength of the optical fiber Bragg grating 430 at the same power level. Therefore, two input ports are needed. One input port is the input port 421 for receiving the optical signal coming out of the fiber Bragg grating 430. The other is the input port 422 for receiving an optical signal to be added.

Meanwhile, as mentioned above, the optical signal reflected from the optical fiber Bragg grating 430 travels in the backward direction opposite to the original traveling direction, and enters the first optical tap coupler 410 with 90% or more coupling ratio. The reflected optical signal is split again according to the coupling ratio of the first optical tap coupler 410. Accordingly, 90% or more (for example, 99%, 95%, 90%) of the reflected optical signal moves to the input port 411 to which the multi-wavelength optical signals were input, and its remaining signal (for example, 1%, 5%, 10%) moves to the drop port 412 of the first optical tap coupler 410. It is noted that because the power level of the reflected optical signal traveling to the input port 411 is high, it is possible for this signal to affect an optical transmitter (not shown) coupled to the input port. However, because currently-used optical transmitters mostly include an isolator on the end of the transmitting portion thereof, the reflected signal will not affect the optical transmitter. Of course, when using an optical transmitter with no isolator, an isolator should be added on the optical transmitter in order to minimize the effect of the reflected optical signal. On the other hand, the power level of the optical signal traveling to the drop port 412 depends on the coupling ratio of the first optical tap coupler 410. For example, in the case of using an optical tap coupler with 99% coupling ratio, the insertion loss experienced by this dropped optical signal is about −20 dB, in the case of 95% coupling ratio, it is about −13 dB, and in the case of 90%, it is about −10 dB. In the case of using an optical tap coupler with 99% coupling ratio, when the power level of the input optical signal is 0 dBm, the power level of the optical signal extracted through the drop port 412 is theoretically −20.04 dBm. Such a low power level of the optical signal extracted through the drop port 412 may cause a problem. However, because the field of application of the present invention is obviously an optical subscriber network that operates in relatively low speed (for example, 155 Mbps or 622 Mbps), the problem is negligible for the following reason. That is, by adopting an optical receiver having relatively high reception sensitivity, suitable for such a low speed optical subscriber network, 10⁻⁹ BER (Bit Error Rate) can be achieved when the received power level is about −20.04 dBm (in the case of general 155 Mbps-level optical receivers, the received optical power level for achieving 10⁻⁹ BER is in the range of −38 to −40 dBm). Thus, the device of the present invention can be sufficiently applied to such a low speed optical subscriber network.

On the other hand, the multi-wavelength optical signals exiting from the fiber Bragg grating 430 encounters the second optical tap coupler 420, that is, a 50/50 optical tap coupler. The optical signal entering the second optical tap coupler 420 through the input port 421 of the second optical tap coupler is transmitted through the output port 423 of the second optical tap coupler after experiencing an insertion loss of about 3 dB due to the operating principle of the second optical tap coupler 420. This 3 dB insertion loss is higher than the 2 dB insertion loss of the passed channel optical signal of the prior art optical add/drop device that is widely used and includes the optical circulator and the optical fiber Bragg grating as mentioned above. Like this, the present invention is seemingly weak in terms of the insertion loss, relative to the prior art. However, the additional insertion loss of 1 dB can be compensated by a low cost optical amplifier for LAN (Local Area Network) or MAN (Metro Area Network), and therefore the add/drop device of the present invention can be satisfactorily applied to the real optical subscriber network.

In the adding operation, an optical signal with the same wavelength as the resonance wavelength of the optical fiber Bragg grating 430 is launched into the 50/50 optical tap coupler 420 through the add port 422, and the added optical signal is combined with the multi-wavelength optical signals exiting from the Bragg grating 430 in coupling region of the 50/50 optical tap coupler 420, and then the combined signals are transmitted through the output port 423 of the second optical tap coupler. Like the multi-wavelength optical signal, the added optical signal has 3 dB insertion loss while passing through the second optical tap coupler 420 with 50% coupling ratio.

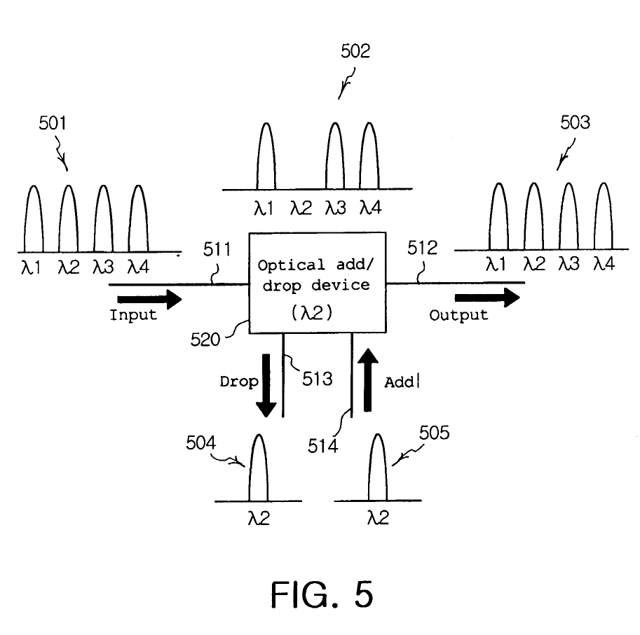

FIG. 5 is a conceptual view showing the operating principle of the optical add/drop device according to the embodiment of the present invention. As shown in this figure, when a channel 501 with four different wavelengths is injected into the optical add/drop device 520 according to the present invention through an input port 511, a signal 504 having a desired wavelength is dropped (extracted) through a drop port 513, and the remaining three-wavelength signals 503 travel to the output port 512 without being affected.

When a desired signal 505 having the same wavelength as the wavelength of the dropped (extracted) signal is inserted through the add port 514, the added signal is combined with the three-wavelength signals 503, so that the combined signals includes all wavelengths.

As apparent from the above description, an optical add/drop device according to the present invention uses a combination of an optical tap coupler and an optical fiber Bragg grating, instead of a combination of an optical circulator and an optical fiber Bragg grating. Therefore, the cost is 10 times lower than the prior art adopting the optical circulator, and the configuration is simple. In addition, the implementation is very easy because the already-existing mature components can be utilized as they are.

Accordingly, the optical add/drop device is expected to be a very attractive low-priced device for assigning one WDM wavelength to each subscriber and for allowing signal exchange between the users through the medium of wavelengths in future WDM optical subscriber networks.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. An optical add/drop device for use in a WDM (Wavelength division Multiplex) based optical subscriber network, the device comprising:
a first optical splitting/coupling means for receiving, as input signals, WDM multi-wavelength optical signals, splitting the received optical signals according to a specific coupling ratio, outputting the split optical signals, splitting an optical signal having a specific wavelength, among the outputted multi-wavelength optical signals, which come back after being reflected, and extracting the split optical signal;
an optical transmitting/reflecting means for reflecting the optical signal having the specific wavelength among the multi-wavelength optical signals outputted from the first optical splitting/coupling means toward the first optical splitting/coupling means, and passing the multi-wavelength optical signals having the remaining wavelengths other than the specific wavelength; and
a second optical splitting/coupling means for receiving the multi-wavelength optical signals exiting from the optical transmitting/reflecting means, inserting a new optical signal having a specific wavelength, combining the inserted optical signal and the received optical signals according to a specific coupling ratio, and outputting the combined optical signals.

2. The optical add/drop device according to claim 1, wherein the first optical splitting/coupling means has a coupling ratio of 90% or more.

3. The optical add/drop device according to claim 1, wherein the second optical splitting/coupling means has a coupling ratio of 50%.

4. The optical add/drop device according to claim 1, wherein the first optical splitting/coupling means inserts, as the insertion signal, the new optical signal having the same wavelength band as that of the extracted optical signal.

5. The optical add/drop device according to claim 1, wherein the second optical splitting/coupling means combines the inserted optical signal and the received optical signals at the same power level.

6. The optical add/drop device according to claim 1, wherein the optical transmitting/reflecting means reflects an optical signal with a wavelength equal to a predetermined resonance wavelength of the optical transmitting/reflecting means, among the multi-wavelength optical signals outputted from the first optical splitting/coupling means, toward the first optical splitting/coupling means.

7. The optical add/drop device according to claim 1, wherein the first and second optical splitting/coupling means are tap couplers.

8. The optical add/drop device according to claim 1, wherein the optical transmitting/reflecting means is an optical fiber Bragg grating.
